(19) United States
(12) Patent Application Publication
(10) Pub. No.: US 2026/0185944 A1
(43) Pub. Date: Jul. 2, 2026

(54) DAMAGE DETECTION APPARATUS, SYSTEM, AND METHOD

(71) Applicant: Caleb Wagner, Holladay, UT (US)

(72) Inventor: Caleb Wagner, Holladay, UT (US)

(21) Appl. No.: 19/438,315

(22) Filed: Dec. 31, 2025

Related U.S. Application Data
(60) Provisional application No. 63/740,988, filed on Dec. 31, 2024.

(51) Int. Cl. G01N 21/88; G01N 21/95

(52) U.S. Cl. CPC G01N 21/8806; G01N 21/95; G01N 2021/8816; G01N 2201/062; G01N 2201/0634; G01N 2201/0635

(57) ABSTRACT

A damage detection apparatus may include a housing, lighting, one or more cameras, a power supply, a diffuser, and a cover. The housing may house the lighting, the one or more cameras, the power supply, and the diffuser. The cover may form a front face of the housing. The lighting may be a plurality of light emitting diodes emitting light in the range of 700 to 1000 nanometers. The plurality of light emitting diodes may be arranged in the form of a grid. The lighting may project light on an object. The one or more cameras may capture light reflected from the object. A damage detection system may use one or more damage detection apparatuses and a computing device. The computing device may analyze images transmitted to the computing device by the one or more cameras to detect damage to the object.

### RELATED APPLICATIONS

This application claims priority to U.S. Provisional Application Ser. No. 63/740,988, filed on Dec. 31, 2024.

### BACKGROUND OF THE INVENTION

Recent data suggests that the United States has an estimated two hundred and eighty-three million registered vehicles, which includes passenger cars, motorcycles, trucks, busses, and other vehicles. Recent data also suggests that the automotive body shop industry in the United States is estimated to be valued at approximately sixty-eight billion U.S. dollars. It is common for vehicles to change hands whether changing ownership or changing hands for repair, maintenance, or rental purposes where a user other than the owner will be operating the vehicle.

Inspections of vehicles for damage, including body damage, is often done manually by a technician. This can be time consuming and error prone. In some instances, technicians use vehicle imaging to assist in identifying body damage to a vehicle. Known methods in this regard are generally inefficient and error prone.

### SUMMARY OF THE INVENTION

A damage detection apparatus, in one embodiment, may include lighting that is configured to produce light having wavelengths in the range of 700 to 1000 nanometers and one or more cameras configured to capture light having wavelengths in the range of 700 to 1000 nanometers. The damage detection apparatus may also include housing to house the lighting and one or more cameras. Generally, the lighting may be configured to project light away from the housing and onto an object. The cameras may be positioned with lenses of the one or more cameras pointed in the general direction of the projection of the light by the lighting such that the cameras may capture the projected light as it reflects off of an object.

The damage detection apparatus may further include a power supply to provide power to the lighting and to the one or more cameras. The power supply may attach to or be part of the housing.

The housing may further include a cover. The cover may be configured to enclose the lighting within the housing. The cover may allow light from the lighting to transmit through the cover with minimal refraction. The cover may also function to give the housing a clean and finished appearance.

In one embodiment, the lighting may include an array of light emitting diodes arranged in a grid pattern. In this embodiment, the lighting may project a grid pattern of light onto an object, and the one or more cameras may capture the grid pattern of light as it reflects off of the object. In some embodiments, the grid pattern of light may be a diamond grid pattern.

In some embodiments, the lighting may include a plurality of light emitting diode bars each with a diffuser to homogenize and scatter the light. The plurality of light emitting diode bars may be arranged in a vertical positioning equally spaced apart from each other. In this manner, the lighting may project a pattern of vertical bars on to an object, and the one or more cameras may capture the lighting pattern of vertical bars as it reflects off of the object.

In some embodiments, the damage detection apparatus may include a diffuser sheet to homogenize and scatter the light projected from the lighting. The diffuser sheet may partially cover the lighting such that a portion of the projected light is homogenized and scattered such that no specific pattern is formed as the light is projected onto the object from the light passing through the diffuser sheet. The diffuser sheet may extend from the bottom of the housing partially up the housing.

A damage detection system may include one or more damage detection apparatuses configured to detect damage on an object. The damage detection apparatuses may be any of the embodiments described above or herein. The damage detection apparatuses may be positioned to project light onto all views and angles of an object and to capture the light reflecting off of the object.

The damage detection system may also include a computing device communicatively connected to the one or more cameras of the damage detection apparatuses. The computing device may receive captured images from the one or more cameras and analyze the captured images to locate locations of damage on the object and also the scale of the damage.

In some embodiments, the damage detection apparatuses may be arranged in one or more walls. In other embodiments, the damage detection apparatuses may be arranged in an arch whether rounded or squared.

A method to detect damage is also disclosed and may include the step of utilizing one or more damage detection apparatuses as disclosed above or herein. Another step may include placing an object to be analyzed for damage near the one or more damage detection apparatuses. Another step may include projecting light from the lighting of the one or more damage detection apparatuses onto the object. Another step may be capturing light reflected of the object with the one or more cameras of the one or more damage detection apparatuses. Another step may include analyzing the captured light to determine locations of damage on the object. Another step may be analyzing the captured light to determine the scale of damage at specific locations on the object. Another step may include diffusing some of the projected light such that the projected light being diffused uniformly spreads out on a portion of the object.

### BRIEF DESCRIPTION OF THE DRAWINGS

Various embodiments and methods will be described herein and explained with additional specificity and detail through the use of the accompanying drawings, in which:

FIG. 1 illustrates an environmental view of a damage detection system and a vehicle;

FIG. 2 illustrates an environmental view of an alternative embodiment of the damage detection system of FIG. 1 with a vehicle.

FIG. 3 illustrates a perspective view of a damage detection apparatus;

FIG. 4 illustrates an exploded perspective view of the damage detection apparatus of FIG. 3;

FIG. 5 illustrates an exploded perspective view of an alternative embodiment of the damage detection apparatus of FIGS. 3 and 4;

FIG. 6 illustrates a front elevational view of the damage detection apparatus of FIGS. 3 and 4;

FIG. 7a illustrates a detailed view of a light grid of the damage detection apparatus of FIGS. 3, 4, and 6 taken from the numeral 7 of FIG. 6;

FIG. 7b illustrates a detailed view of light bars of an alternative embodiment of the damage detection apparatus of FIGS. 3, 4, and 6 taken from the numeral 7 of FIG. 6;

FIG. 8 illustrates an environmental view of one embodiment of the damage detection apparatus of FIGS. 3, 4, and 6 and its view of a damaged object;

FIG. 9 illustrates an example of a damage map created by one embodiment of the damage detection apparatus as seen from the display of a computing device;

FIG. 10 illustrates a bottom perspective view of the alternative embodiment of the damage detection apparatus of FIGS. 3, 4, and 6;

FIG. 11 illustrates a front environmental view of the alternative embodiment of FIG. 10 with a car, showing the view of one or more cameras of the alternative embodiment; and

FIG. 12 illustrates a cross-sectional view of the alternative embodiment of FIGS. 10 and 11 taken from the line 12-12 of FIG. 10.

### DETAILED DESCRIPTION OF THE PREFERRED EMBODIMENTS

As shown in the drawings and for purposes of illustration, the one or more embodiments disclosed herein illustrate a damage detection system, apparatus, and method. The damage detection apparatus is generally referred to herein by the reference numeral 10 and the damage detection system is generally referred to herein by the reference numeral 100. The damage detection system 100 may include one or more damage detection apparatuses 10 and a computing device 12. The one or more damage detection apparatuses 10 may include lighting and one or more cameras. The lighting may project light onto an object, and the one or more cameras may capture images of the object from the projected light reflecting off of the object. The one or more cameras may be communicatively connected to the computing device and may transmit the captured images to the computing device for viewing by a user. The computing device may analyze the captured images of the reflected light to locate, highlight, and scale damage to the object such as, but not limited to, dents, scratches, and other abnormalities.

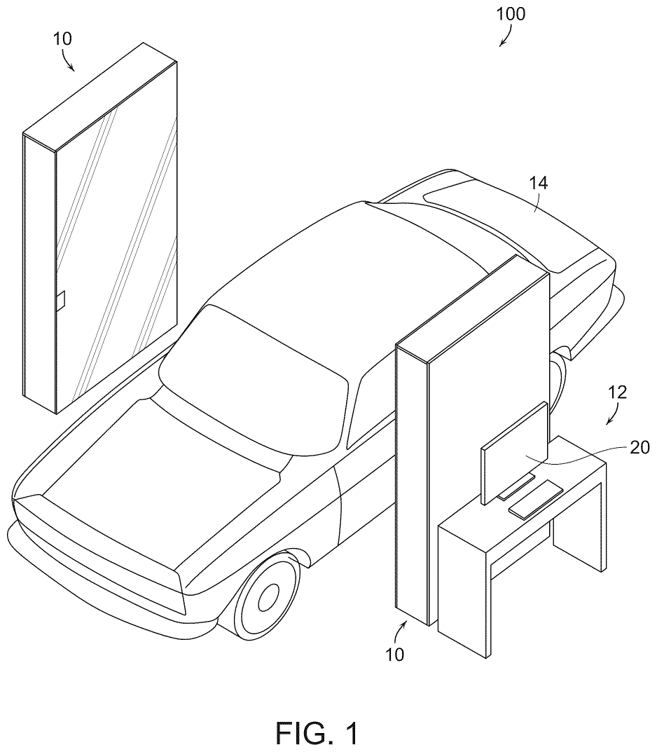

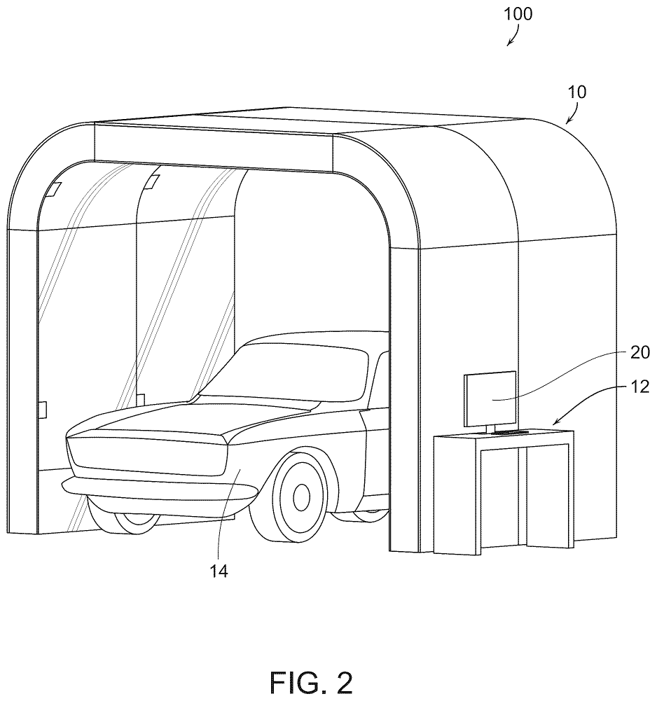

With reference now to FIGS. 1 and 2, various embodiments of a damage detection system 100 are illustrated. As indicated above, the damage detection system 100 may be comprised of one or more damage detection apparatuses 10 and a computing device 12. The one or more damage detection apparatuses 10 and the computing device 12 may be communicatively connected so as to work together to detect and scale damage, including but not limited to, dents, scratches, and other abnormalities, in or on the surface of an object 14. The object 14 may be any object with smooth surfaces, such as but not limited to, vehicles such as cars, vans, trucks, SUVs, motorcycles, boats, buses, ATVs, wave runners, jet skis, etc. The one or more damage detection apparatuses 10 may be in the form of walls or tunnels. In embodiments using the wall damage detection apparatus 10, it may be preferrable for the system 100 to include two damage detection apparatuses 10 spaced apart such that an object 14 may be placed between the two damage detection apparatuses 10. In embodiments using the tunnel damage detection apparatus 10, it may be preferrable for the system 100 to include only one damage detection apparatus 10. In these embodiments, the damage detection apparatus 10 may be large enough for the object 14 to fit within the tunnel of the damage detection apparatus 10.

The one or more damage detection apparatuses 10 may include lighting 16 and one or more cameras 18. The lighting 16 may project light onto the object 14 such that the light reflects off of the object 14. The one or more cameras 18 may be configured to capture images of the reflected light from the object 14. The cameras 18 may be communicatively connected to the computing device 12 and may be configured to transmit the captured images to the computing device 12. The computing device 12 may process the captured images to find and indicate damage to the object such as, but not limited to, dents, scratches, or other abnormalities. The computing device 12 may present the processed images to a user via a user interface on a screen 20. Although shown as part of the damage detection apparatus 10, in some embodiments of the system, the one or more cameras 18 may be separate and distinct from the damage detection apparatus 10. In other embodiments, instead of having the computing device 12 process the captured images, the one or more cameras 18 may themselves process the captured images to find and indicate damage to the object such as, but not limited to, dents, scratches, or other abnormalities. The one or more cameras 18 may present the processed images to a user via a user interface on a screen 20.

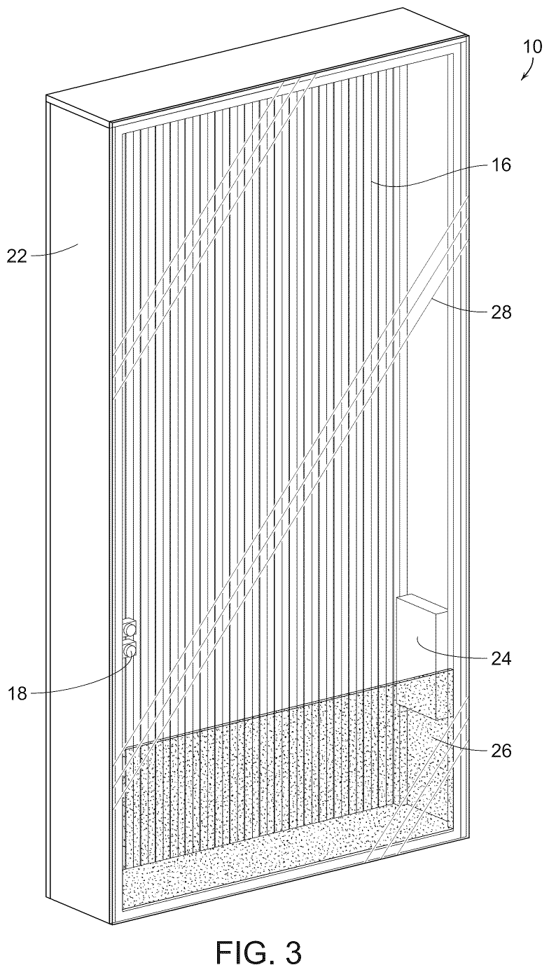

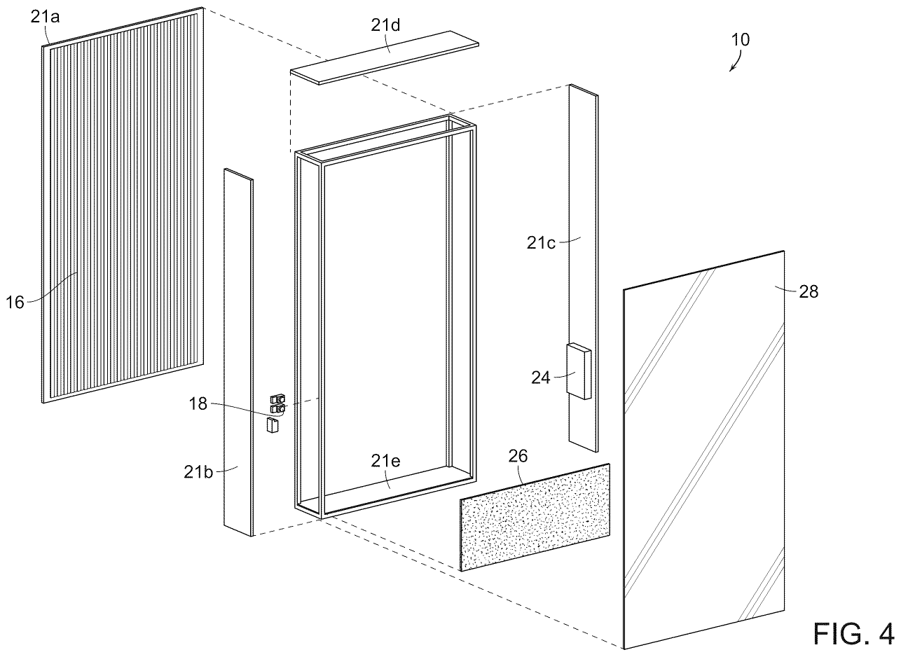

With reference now to FIGS. 3 and 4, an embodiment of a damage detection apparatus 10 is illustrated. Generally, the damage detection apparatus 10 may include one or more of the following: a housing 22, a power supply 24, one or more cameras 18, lighting 16, a diffuser 26, and a cover 28. The housing 22 may be configured to house or enclose one or more of the power supply 24, one or more cameras 18, lighting 16, diffuser 26, and cover 28 which may be part of the housing 22. The housing 22 may also be configured to give the damage detection apparatus 10 a clean and finished appearance. The housing 22 may include a back wall 21a, a first side wall 21b, a second side wall 21c, a top wall 21d, and a bottom wall 21e. Put together, the walls 21a-e may form a cuboid shape with an open front face. In some embodiments, the housing 22 may include a frame 23. The frame 23 may be configured to provide support to the housing 22 such that the housing 22 will remain rigid.

The lighting 16 may be secured or attached to the back wall 21a of the housing 22. In some embodiments, the lighting 16 may cover a majority of the front face of the back wall 21a. In some embodiments, the lighting 16 may include a plurality of light emitting diodes. In some embodiments, the light emitting diodes of the lighting 16 may by infrared light emitting diodes having a wavelength between 700 and 1000 nanometers.

As mentioned above, in some embodiments, the damage detection apparatus 10, may include one or more cameras 18. In general, the damage detection apparatus 10 may include enough cameras 18 to have a full field of vision over the object 14 being inspected and viewed by the damage detection apparatus 10 but may include fewer cameras 18 to have only a partial field of vision over the object 14. In some embodiments, the one or more cameras 18 may fall into one or more of the following different types of cameras: full spectrum cameras capturing a full spectrum of light, RGB cameras with one or more filters capturing only red, green and blue components of the visible spectrum in the 400-700 nanometer range, infrared cameras with one or more filters, such as single bandpass filters capturing a single wavelength of light in the 700 to 1000 nanometer range, and infrared/visible cameras with one or more filters, such as dual bandpass filters capturing a single wavelength of light in the 700 to 1000 nanometer range and all visible light in the 400 to 700 nanometer range.

The power supply 24 may be positioned on any one of the walls 21a-e and may provide power to the lighting 16 and to the one or more cameras 18. The power supply 24 may connect to an external power source.

Some embodiments of the damage detection apparatus 10 may include a diffuser 26. The diffuser 26 may be a diffuser sheet configured to homogenize and scatter the light projected by the lighting 16. The diffuser 26 may act as a partial front cover for the cabinet 26 extending from the bottom of the cabinet 26 but not covering the entire front of the cabinet 26. For example, in some embodiments, the diffuser 26 will have a height in the range of twelve to twenty-eight inches while the height of the cabinet 22 may be in the range of five to nine feet or higher.

The cover 28 may be part of the housing 22 and may cover the entirety of the front of the housing 22. In some embodiments, the cover 28 may cover all of the inner components of the housing 22, including the lighting 16, the one or more cameras 18, the power supply 24, and the diffuser 26. In some embodiments, the lenses of the one or more cameras 18 may extend through the cover 28. In some embodiments, the lenses of the one or more cameras may be flush with the cover 28. In some embodiments, the cover 28 may be a polycarbonate material, acrylic material, or the like. The polycarbonate material, acrylic material, or the like may be transparent or translucent. In some embodiments, the cover 28 may be a polycarbonate material, acrylic material, or the like that is translucent and only lets light having wavelengths between 700 to 1000 nanometers through with minimal refraction. The cover 28 may be configured to give the housing 22 a finished and clean appearance.

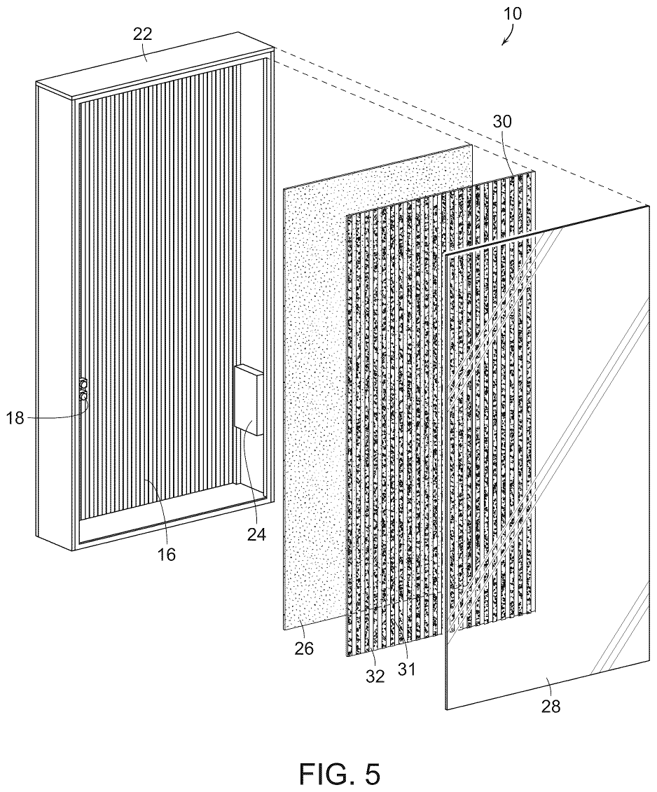

With reference now to FIG. 5, an alternative embodiment of the damage detection apparatus 10 is illustrated. In the alternative embodiment, the damage detection apparatus 10 may include a housing 22, lighting 16, one or more cameras 18, a power supply 24 and a cover 28, all as previously described in connection with other embodiments. The alternative embodiment may further include a diffuser 26 that completely covers the front of the cabinet 22. The alternative embodiment may further include a structured lighting sheet 30. The structured lighting sheet 30 may include blocking strips 31 and passthrough strips 32. The blocking strips 31 may be opaque so as to block all light from passing through, while the passthrough strips 32 may be transparent or translucent letting all light through or certain wavelengths of light through. In some embodiments, for example, the passthrough strips 32 may be translucent only letting light with wavelengths in the range of 700-1000 nm through. The blocking strips 31 and the passthrough strips 32 may alternate on the structured lighting sheet 30. In some embodiments, the blocking strips 31 and the passthrough strips 32 may be oriented vertically. The cover 28 may cover both the diffuser 26 and the structured lighting sheet 30. In some embodiments, the structured lighting sheet 30 may extend the full height of the housing 22. In other embodiments, the structured lighting sheet 30 may extend from the top of the housing 22 and end before it reaches the bottom of the housing 22. In these embodiments, the structured lighting sheet 20 may end twelve to twenty-twenty eight inches from the bottom of the housing 22.

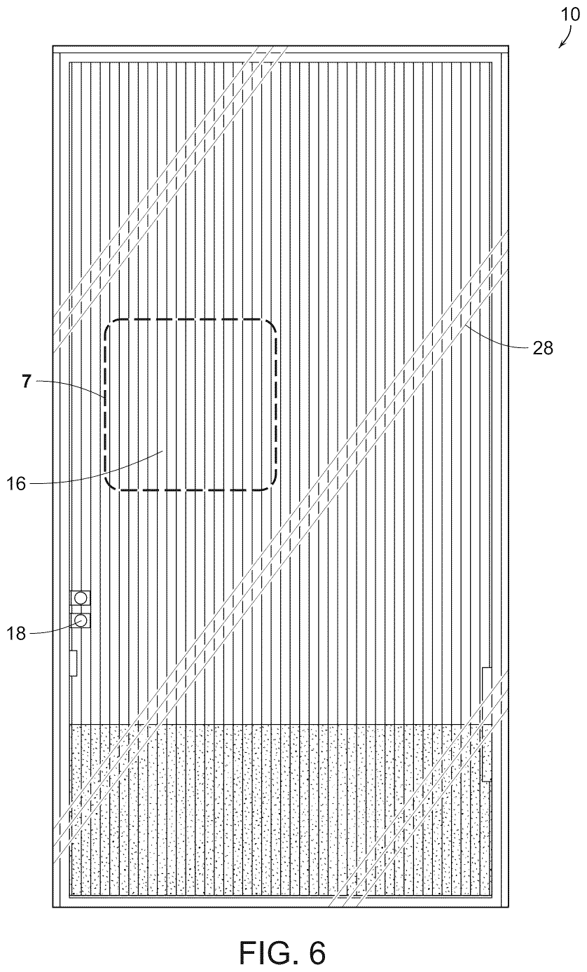

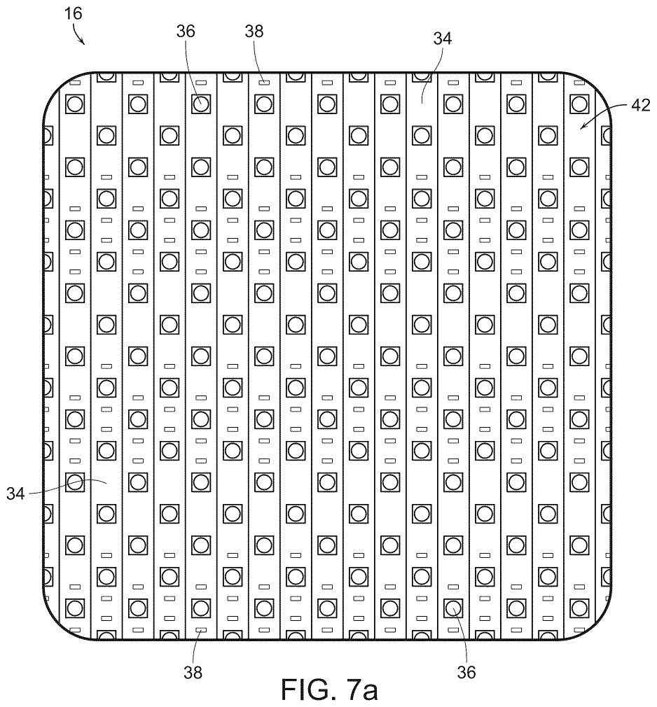

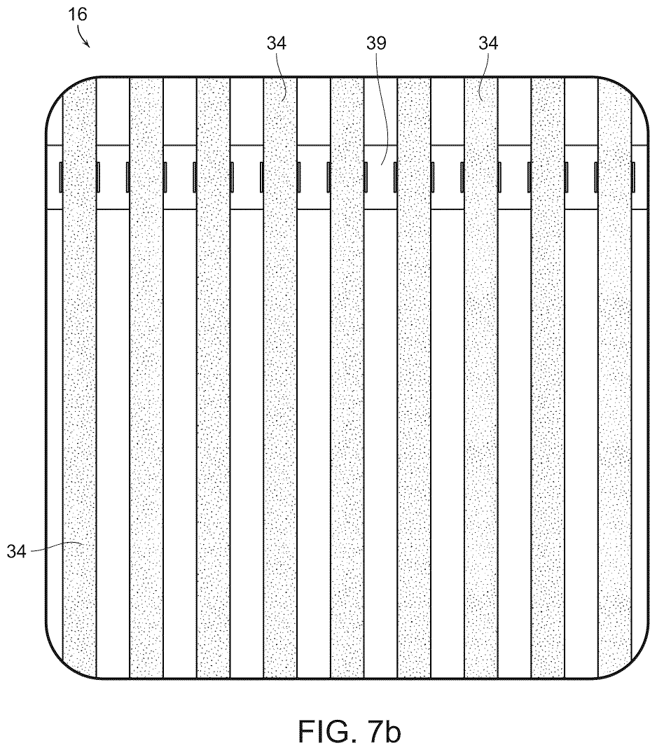

With reference now specifically to FIGS. 6 and 7a, the lighting 16 for some embodiments, is shown in more detail. In some embodiments, the lighting 16 may be light emitting diode strips 34. The light emitting diode strips 34 may include a plurality of light emitting diodes 36. The light emitting diode strips 34 may further include a plurality of resistors 38. The plurality of light emitting diodes 36 and the plurality of resistors 38 may be connected to a flexible or rigid print circuit board 40. The light emitting diode strips 34 may be oriented vertically, horizontally or at some other angle. The light emitting diode strips 34 may be configured such that the light emitting diodes 36 form a diamond grid pattern 42 as shown in FIG. 7. In other embodiments, the light emitting diode strips 34 may be configured such that the light emitting diodes 36 form a square grid. One skilled in the art, would recognize that other embodiments may not include light emitting diode strips 34, but may just be a plurality of light emitting diodes 36 connected by some other means known in the art. As mentioned above, the plurality of light emitting diodes 36 may be arranged to form a diamond grid 42 as illustrated in FIG. 7. In other embodiments, the plurality of light emitting diodes 36 may be arranged to form a square grid. In yet other embodiments, the lighting 16 may project light to form other patterns such as a vertical bar pattern, a horizontal bar pattern, or other patterns of light. In some embodiments, the light emitting diodes 36 may emit light with wavelength in the range of 700 to 1000 nanometers.

In one embodiment, the light emitting diodes 36 may emit light with a wavelength of 940 nanometers. In another embodiment, the light emitting diodes 36 may emit light with a wavelength of 850 nanometers. In another embodiment, the light emitting diodes 36 may fall into different sets, with each set emitting different wavelengths of light.

In this embodiment, the light projected onto the object by the lighting 16 may be a grid pattern of dots, such as a diamond grid pattern.

With reference not to FIG. 7b, an alternative embodiment of the lighting 16 is shown as used in some embodiments of the damage detection apparatus 10. In this embodiment, the lighting 16 may be comprised of a plurality of light emitting diode bars 34 supported by a support rack 39. The light emitting diode bars 34 may be positioned in a vertical arrangement with the light emitting diode bars 34 equally spaced apart from each other. Each light emitting diode bar 34 may contain a diffuser to homogenize and scatter the light projected by the light emitting diode bars 34. In this embodiment, the light projected onto the object may be in the pattern of vertical bars.

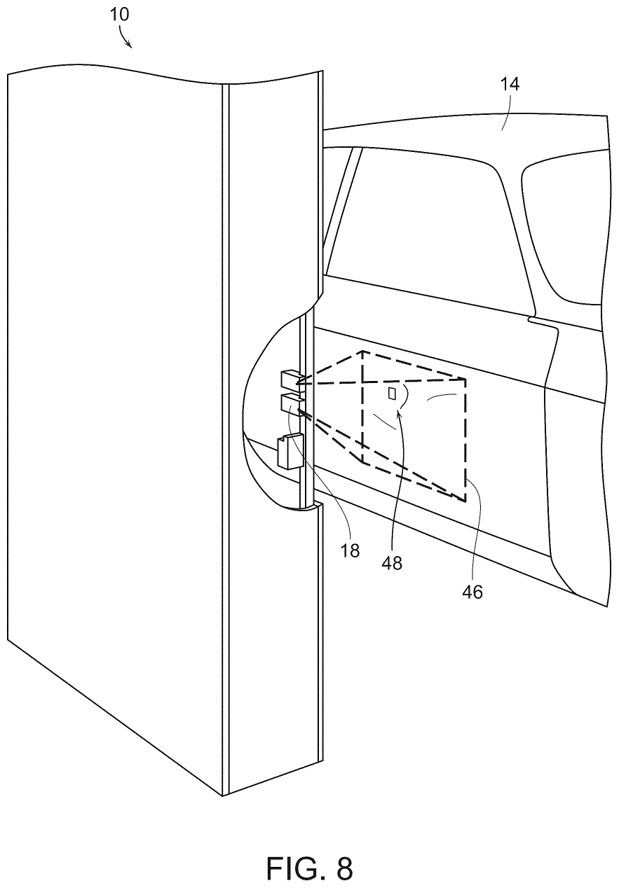

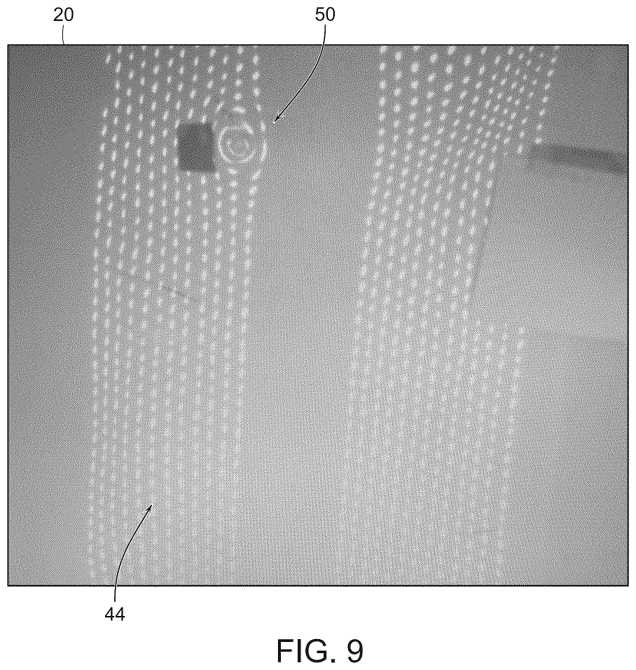

With reference now to FIGS. 8 and 9, the one or more cameras 18, as previously described above, may capture reflected light 44 from the lighting 16 projecting onto the object 14. The captured reflected light 44 may then be presented on the screen 20 of a computing device 12 as best shown in FIG. 9. The one or more cameras 18 may have a field of view 46 of the object 14 being inspected. The field of view 46 of the one or more cameras may be transmitted and stored into memory on the computing device 12 for viewing by a user. For example, if the object 14 being inspected has a surface dent 48, the surface dent will appear on the screen 20 as a disruption 50 to the captured reflected light 42. The computing device 12 may recognize this disruption 50 and highlight or otherwise note the disruption 50 for the user.

FIG. 9 shows the reflected light 42 as a diamond grid pattern as would be the case with the diamond grid pattern 42 of the plurality of light emitting diodes 36 shown in FIG. 7. The reflected light 42 captured may have different patterns depending on the embodiment of the damage detection device 10 being used. The damage detection device 10 with the light emitting diodes 36 in a diamond grid pattern 42 without a diffuser 26 may cause the reflected light 42 to show up as a diamond grid pattern on the computing device 12. The damage detection device 10 with the light emitting diodes 36 in a square grid pattern without a diffuser 26 may cause the reflected light 42 to show up as a square grid pattern on the computing device 12. The damage detection device 10 with the light emitting bars 34 in a vertical and equally spaced-out arrangement may cause the reflected light 42 to show up as a series of vertical bars on the computing device 12. The lighting 16 behind a diffuser 26 may show up as illuminated in no specific pattern on the computing device 12. The lighting 16 behind a diffuser 26 and a structured lighting sheet 30 would be displayed on the computing device 12 matching the pattern of the structured lighting sheet 30. In some embodiments, that pattern may be vertical bars.

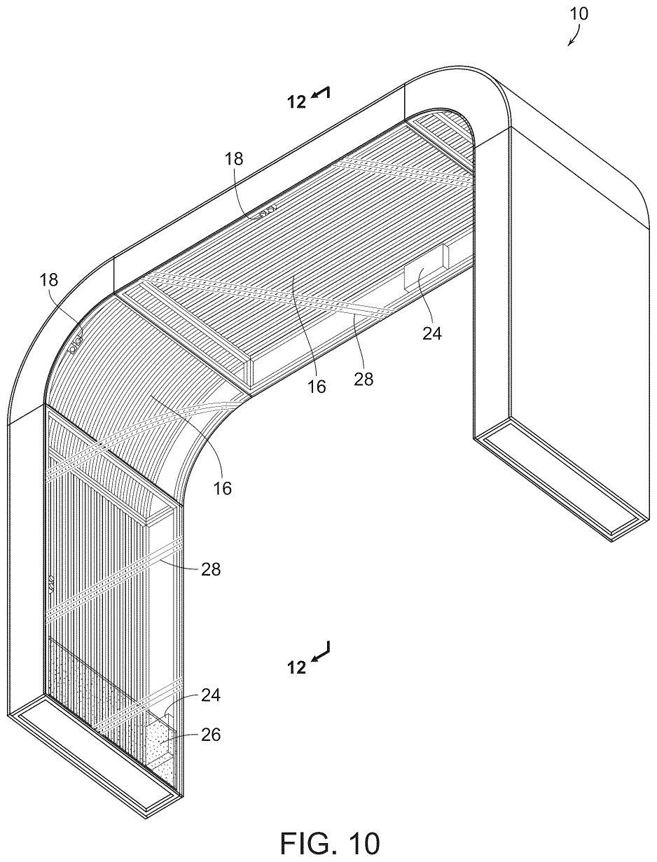

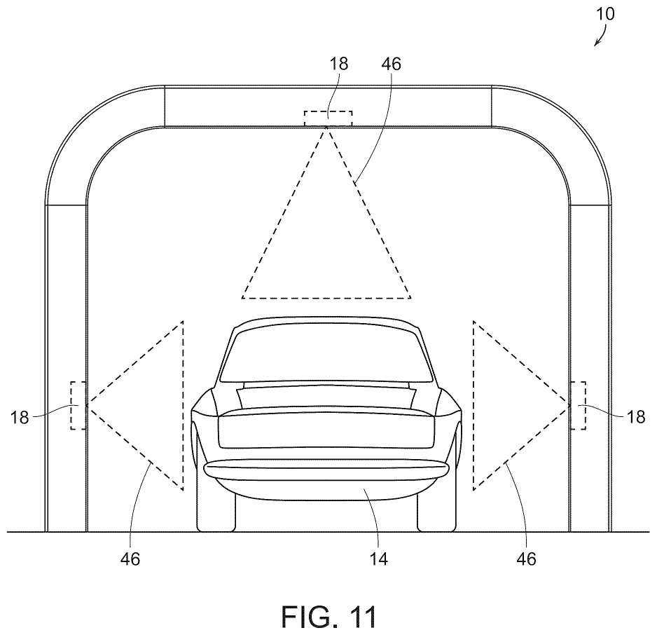

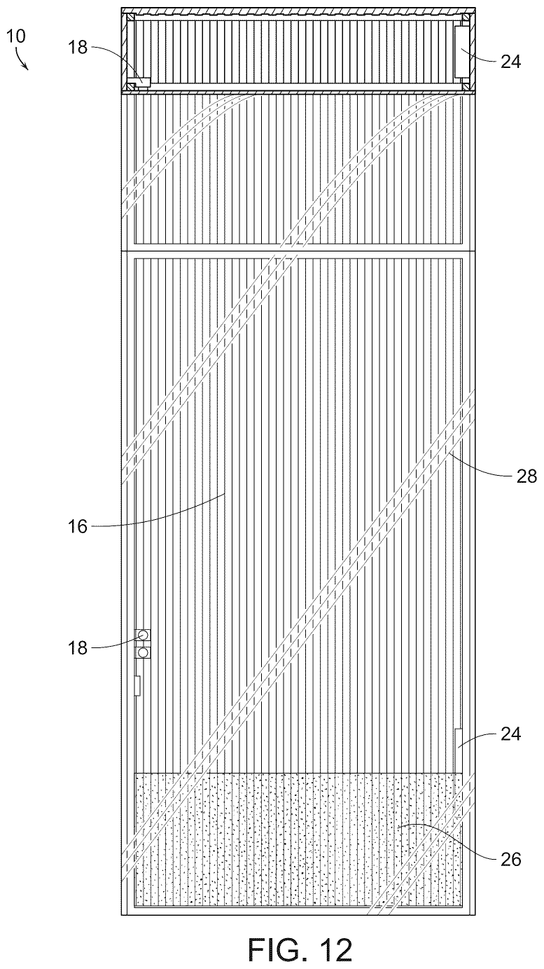

With reference now to FIGS. 10-12, in an alternative embodiment, as previously described above, the damage detection device 10 may be in the form of a tunnel rather than a wall. The tunnel embodiment of the damage detection device 10 may include any of the components described above and be identical to any of the embodiments above asides from the shape of the damage detection device 10 which may be in the form of a tunnel rather than a wall. The tunnel may be large enough such that the object 14 being inspected by the damage detection device 10 may fit within the tunnel. As seen in FIG. 11, the field of views 46 of the one or more cameras 18 may be large enough to cover the entirety of the object 14.

A method to detect damage to an object may include various steps of which one skilled in the art would recognize may be placed in various different orders and arrangements.

One step may include utilizing one or more damage detection apparatuses that include lighting and one or more cameras. The lighting may include a plurality of light emitting diodes emitting light in a range of 700 to 1000 nanometers. The light emitting diodes may be arranged in a grid such as a diamond grid or a square grid.

Another step may include projecting a dot grid pattern of light onto the object from the lighting of the one or more damage detection apparatuses. The projected light may be in the range of 700-1000 nanometers.

Another step may include projecting a dot grid pattern of light at 940 nanometers onto the object from the lighting of the one or more damage detection apparatuses.

Another step may include projecting a dot grid pattern of light at 850 nanometers onto the object from the lighting of the one or more damage detection apparatuses.

Another step may include capturing a reflected light dot grid from the object produced by the grid pattern of light being projected onto the object.

Another step may include transmitting the captured reflected light dot grid to a computing device.

Another step may include analyzing the captured reflected light dot grid to determine places of damage on the object. The computing device may perform the analyzing of the captured reflected light dot grid through a processor. In other embodiments, the one or more cameras may perform the analyzing of the captured reflected light dot grid through one or more processors.

Another step may include detecting deformations in the captured reflected light dot grid to determine places of damage on the object caused by the dots of the grid being altered from the uniform grid. The computing device may perform the detecting deformations and determining places of damage through a processor. In other embodiments, the one or more cameras may perform the detecting deformations and determining places of damage through one or more processors.

Another step may include determining the scale of damage by measuring the distance between the dots in the detected deformations.

Another step may include displaying the captured reflected light dot grid on a user interface.

Another step may include providing information on the location of damage on a user interface.

Another step may include providing information on the scale of damage at a given location on an object on a user interface.

Another step may include diffusing a portion of the lighting to project uniform light onto a portion of the object.

Another step may include capturing the reflected uniform light from the portion of the object.

Another step may include transmitting the captured reflected uniform light from the portion of the object to a computing device.

Another step may include analyzing the captured reflected uniform light to determine places of damage. The analyzing may be done by the computing device using a processor. In other embodiments, the analyzing may be done by the one or more cameras through one or more processors.

Another step may include displaying information about the places of damage from the portion of the object on the user interface.

Another step may include displaying information about the scale of damage at a location from the portion of the object on the user interface.

Another step may include, the object being a vehicle, driving the vehicle slowly past one or more damage detection apparatuses.

Another step may include, the object being a vehicle, driving the vehicle slowly through a damage detection apparatus, the damage detection apparatus being in the form of a tunnel.

Another step may include all of the steps above, except that instead of a grid pattern of light being used, some other pattern of light is used such as structured light bands.

Although specific embodiments, systems, and methods have been described in detail above for purposes of illustration, various modifications may be made without departing from the scope and spirit of the invention. Accordingly, the invention is not to be limited except as by the appended claims.

What is claimed is:

1. A damage detection apparatus comprising:
lighting configured to produce light having wavelengths in the range of 700-1000 nanometers;
one or more cameras configured to capture light having wavelengths in the range of 700-1000 nanometers; and
housing configured to house the lighting and one or more cameras;
wherein the lighting is configured to project light away from the housing and wherein the one or more cameras are positioned with lenses of the one or more cameras pointed in the general direction of the projection of the light by the lighting.

2. The damage detection apparatus of claim 1, further comprising a power supply configured to provide power to the lighting and one or more cameras.

3. The damage detection apparatus of claim 1, wherein the housing is comprised of a cover configured to enclose the lighting within the housing.

4. The damage detection apparatus of claim 3, wherein the cover is configured to allow light from the lighting to transmit through the cover with minimal refraction.

5. The damage detection apparatus of claim 1, wherein the lighting is comprised of an array of light emitting diodes arranged in a diamond grid pattern and wherein the lighting is configured to project a diamond grid pattern of light onto an object.

6. The damage detection apparatus of claim 5, further comprising a diffuser configured to diffuse some of the light projected from the lighting, the diffuser being positioned to cover a bottom portion of the housing, with an upper portion of the housing not being covered by the diffuser.

7. The damage detection apparatus of claim 1, wherein the lighting is comprised of a plurality of light emitting diode bars, the light emitting diode bars being positioned in a vertical configuration, parallel to each other, and equally spaced apart, wherein the lighting is configured to project light in a vertical striped pattern onto an object.

8. The damage detection apparatus of claim 7, wherein the plurality of light emitting diode bars each contain diffusers configured to diffuse the light projected from the lighting.

9. A damage detection system comprising:
one or more damage detection apparatuses configured to detect damage on an object, wherein each of the one or more damage detection apparatuses is comprised of lighting configured to produce light having wavelengths in the range of 700-1000 nanometers and one or more cameras configured to capture light having wavelengths in the range of 700-1000 nanometers; and
a computing device communicatively connected to the one or more cameras of the damage detection apparatuses;
wherein the one or more damage detection apparatuses are positioned to project light onto one or more surfaces of an object, wherein the one or more cameras are configured to capture light reflecting off of the object, and wherein the computing device is configured to process images captured by the one or more cameras to locate one or more locations of damage on the object.

10. The damage detection system of claim 9, wherein the lighting of the one or more damage detection apparatuses is comprised of an array of light emitting diodes arranged in a diamond grid pattern and being configured to project a diamond grid pattern of light onto an object.

11. The damage detection system of claim 10, wherein at least one of the damage detection apparatuses is further comprised of a diffuser sheet partially covering the lighting and being configured to diffuse the light projected from the portion of lighting covered by the diffuser sheet.

12. The damage detection system of claim 10, wherein the computing device further processes the images captured by the one or more cameras to determine the size of the damage on the object at the one or more detected locations of damage.

13. The damage detection system of claim 9, wherein the lighting of the one or more damage detection apparatuses if comprised of a plurality of light emitting diode bars, the light emitting diode bars being positioned in a vertical configuration, parallel to each other, and equally spaced apart, wherein the lighting is configured to project light in a vertical striped pattern onto an object.

14. The damage detection system of claim 13, wherein the plurality of light emitting diode bars each contain diffusers configured to diffuse the light projected from the lighting.

15. The damage detection system of claim 9, wherein the one or more damage detection apparatuses are arranged in an arch.

16. The damage detection system of claim 9, wherein each of the one or more damage detection apparatuses is further comprised of a housing configured to house the lighting, wherein the housing is comprised of a cover covering the lighting and allowing light projected from the lighting to transmit through the cover with minimal refraction.

17. A method to detect damage to an object comprising:
utilizing one or more damage detection apparatuses comprised of lighting configured to produce light having wavelengths in the range of 700-1000 nanometers and one or more cameras configured to capture light having wavelengths in the range of 700-1000 nanometers;
placing an object to be analyzed for damage near the one or more damage detection apparatuses;
projecting light onto the object from the lighting of the one or more damage detection apparatuses;
capturing light reflected of the object with the one or more cameras of the one or more damage detection apparatuses; and
analyzing the captured light to determine locations of damage on the object.

18. The method of claim 17, wherein the lighting of the one or more damage detection apparatuses is comprised of an array of light emitting diodes arranged in a diamond grid pattern such that the step of projecting light onto the object from the lighting includes projecting a diamond grid pattern of light onto the object.

19. The method of claim 18, further comprising the step of analyzing the captured light to determine the scale of damage at the locations of damage detected.

20. The method of claim 19, further comprising the step of diffusing some of the projected light such that the projected light uniformly spreads out on a portion of the object.
